(19) United States
(12) Patent Application Publication
(10) Pub. No.: US 2006/0233614 A1
(43) Pub. Date: Oct. 19, 2006

(54) Ejector/injector tool for use with cone penetrometer

(75) Inventors: Lorraine M. LaFreniere, Joliet, IL (US); David H. Surgnier, Ada, OK (US)

Correspondence Address: JOAN PENNINGTON, 535 NORTH MICHIGAN AVENUE, UNIT 1804, CHICAGO, IL, 60611, US

(73) Assignee: THE UNIVERSITY OF CHICAGO

(21) Appl. No.: 11/104,894

(22) Filed: Apr. 13, 2005

(51) Int. Cl. A01G 25/09; B09C 1/08

(52) U.S. Cl. 405/128.75; 239/587.1; 239/146

(57) ABSTRACT

An ejector/injector tool for use with cone penetrometers includes a hollow body portion connected at one end with the CPT rod string and connected at the other end with an annular valve body having a central tubular opening. An extendable delivery tube containing a plurality of fluid delivery ports passes through the valve body into the hollow body. A plurality of O-rings in the valve body ensures a liquid tight fit between the valve body and the delivery tube. The interior end of the delivery tube is coupled to a stop ring containing a plurality of fluid paths to permit the entry of fluid into the delivery tube.

### CONTRACTUAL ORIGIN OF THE INVENTION

The United States Government has rights in this invention pursuant to Contract No. W-31-109-ENG-38 between the United States Government and Argonne National Laboratory.

### FIELD OF THE INVENTION

The present invention relates to cone penetrometers (CPT). More specifically this invention relates to an ejector/injector tool for use with cone penetrometers. Still more specifically this invention relates to an ejector/injector tool, which permits the precision application of remedial chemicals or other materials directly into contaminated sites.

### DESCRIPTION OF THE RELATED ART

Cone penetrometers are truck-mounted devices that can rapidly penetrate the ground with little disturbance and can be used to characterize the depth, type, and extent of underground contamination. Once this information is known, the problem becomes one of how to effectively remediate the contaminated site.

Depending on the depth and extent of contamination, a number of decontamination methods are available such as, for example, soil washing, bioremediation, pump and treat and soil air extraction. All are expensive and require substantial time and effort.

For certain types of contamination it would be cost effective if it were possible to direct the decontamination materials directly into the contaminated area. Such tools are available, but all have limitations such as the ability to treat only a limited vertical area and only a limited ability to control the amount of treatment material released into the soil.

A principal object of the present invention is to provide an ejector/injector tool for use with cone penetrometers.

Other important objects of the present invention are to provide such an ejector/injector tool substantially without negative effect and that overcome some of the disadvantages of prior art arrangements.

### SUMMARY OF THE INVENTION

In brief, an ejector/injector tool for use with cone penetrometers is provided. The ejector/injector tool includes a hollow body portion connected at one end with the CPT rod string and connected at the other end with an annular valve body having a central tubular opening. An extendable delivery tube containing a plurality of fluid delivery ports passes through the valve body into the hollow body. A plurality of O-rings in the valve body ensures a liquid tight fit between the valve body and the delivery tube. The interior end of the delivery tube is coupled to a stop ring containing a plurality of fluid paths to permit the entry of fluid into the delivery tube.

In accordance with features of the invention, the ejector/injector tool of the invention provides a delivery system for placing a controlled amount of remediation materials such as nutrients to enhance microbial activity, allows the inoculation with engineered contaminant specific microbes to augment existing populations. The ejector/injector tool of the invention allows the delivery of chemical tracers to study groundwater/plume movement, and also allows the delivery of chemicals such as oxygen releasing compounds (ORC's) and others to aid in degradation/remediation of contaminant plumes in subsurface aquifers and soils, directly into the contamination zone.

### BRIEF DESCRIPTION OF THE DRAWINGS

The present invention together with the above and other objects and advantages may best be understood from the following detailed description of the preferred embodiments of the invention illustrated in the drawings, wherein:

FIGS. 1A, 1B, 1C and 1D together illustrate not to scale the ejector/injector tool in accordance with a preferred embodiment of the invention;

FIG. 2 illustrates not to scale the ejector/injector tool of 1A, 1B, 1C and 1D in a closed position such as when being inserted into a formation and when being withdrawn from the formation; and

FIG. 3 illustrates not to scale the ejector/injector tool of FIGS. 1A, 1B, 1C and 1D in an open position to allow treatment of a discrete area with one set of fluid delivery ports exposed.

### DETAILED DESCRIPTION OF THE PREFERRED EMBODIMENTS

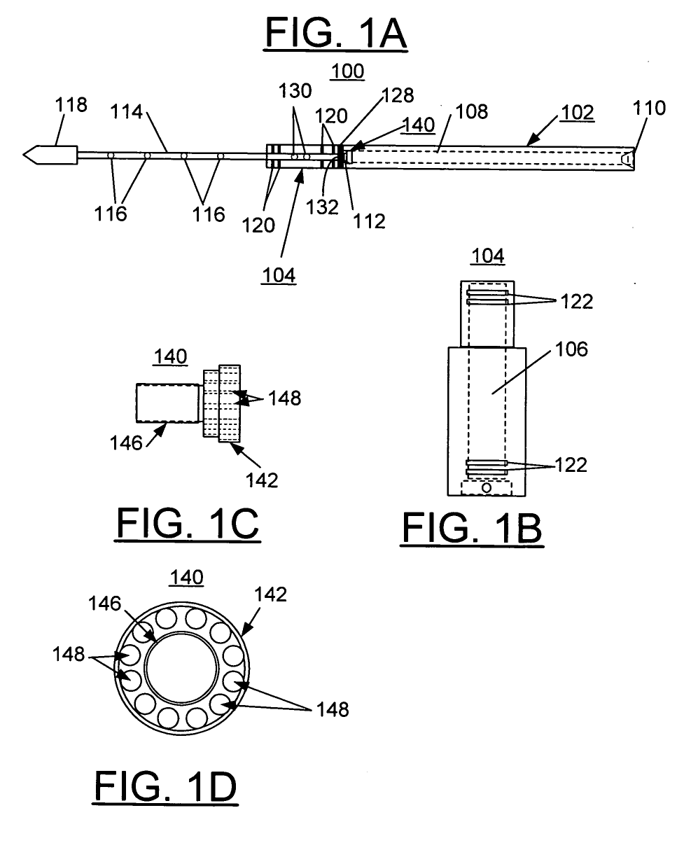

Having reference now to the drawings, in FIGS. 1A, 1B, 1C and 1D there is shown an ejector/injector tool for use with cone penetrometers (CPT) in accordance with the preferred embodiment generally designated by the reference character 100. Ejector/injector tool 100 is shown not to scale in FIGS. 1A, 1B, 1C and 1D in plan views with selected interior details illustrated in dotted line.

In accordance with features and advantages of the invention, the ejector/injector tool 100 includes among others features, the ability to substantially pinpoint the application of selected nutrients or chemicals to very specific zones in the subsurface, flexible application rates, such as, from 0.25 GPM up to 4 GPM, minimally invasive methods of application and delivery, minimal exposure of personnel to chemicals by reducing direct contact of personnel to chemicals, and an operational depth of, for example, from five feet to three hundred feet below ground level.

Ejector/injector tool 100 is used with a CPT rod string generally designated by the reference character 102. Ejector/injector tool 100 includes an annular valve body generally designated by the reference character 104 having a central tubular opening 106, as shown in dotted line in FIG. 1B.

As best seen in FIG. 1A, ejector/injector tool 100 includes a hollow body portion 108 connected at one end 110 with the CPT rod string 102 and connected at an opposite end 112 with the annular valve body 104. The hollow body portion 108 is an elongated tubular member formed by a seamless steel tubing of a predefined diameter and wall thickness. The hollow body portion 108 includes, for example an internal thread at end 110 for threadingly connecting with the CPT rod string 102.

As shown in FIG. 1A, ejector/injector tool 100 includes an extendable delivery tube 114 contains a plurality of fluid delivery ports 116 spaced apart along the length of the elongated delivery tube. The extendable delivery tube 114 passes through the central tubular opening 106 of the valve body 104 into the hollow body portion 108. A respective set, such as a plurality of aligned fluid delivery ports 116 is formed, for example, drilled through the delivery tube 114, such as about 120 degrees apart from each other. The plurality of sets of fluid delivery ports 116 are spaced apart along the length of the elongated delivery tube, for example, at one-foot intervals to enable the application of selected nutrients or chemicals to one or multiple very specific zones in the subsurface.

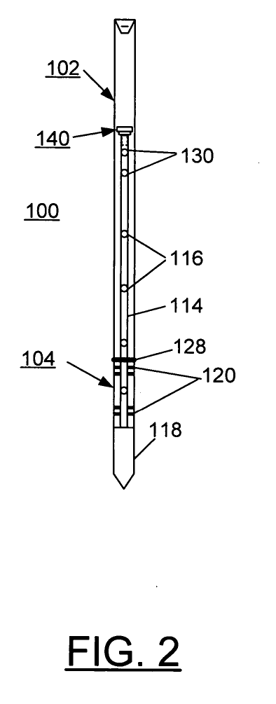

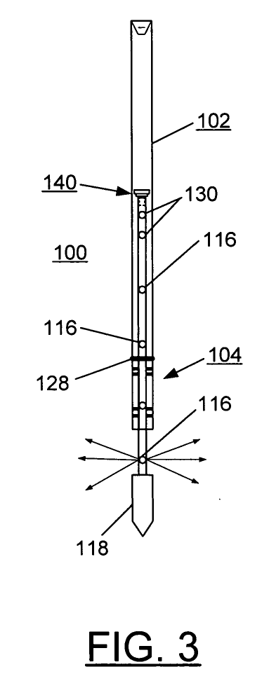

In FIG. 1A, the extendable delivery tube or inner tube 114 is shown in a fully extended position. An attached end conical shaped member or cone 118 is attached to a distal end of the delivery tube 114. The conical shaped member 118 is removably latched to the valve body 104 in a closed position of the ejector/injector tool 100 as illustrated in FIG. 2 and is unlatched from the valve body 104 when the CTP rod string 102 is retracted to provide an open position of the ejector/injector tool 100 as illustrated in FIG. 3.

Ejector/injector tool 100 is provided in the closed position as illustrated in FIG. 2 while being inserted into a contamination area. Ejector/injector tool 100 also is provided in the closed position with the CPT rod string 102 moved down and latched to the valve body 104 before the ejector/injector tool 100 is removed from the contamination area.

Referring also to FIG. 1B, ejector/injector tool 100 includes a plurality of O-rings 120 for providing seals for a liquid tight fit between the delivery tube 114 and the valve body 104. Each O-ring 120 is received and retained within a respective recess 122 within the valve body 104.

As shown in FIG. 1A, ejector/injector tool 100 includes an O-ring 128 carried by the hollow body portion 108 proximate to the end 112 of the hollow body portion 108 for providing a liquid tight fit between the hollow body portion 108 and the CPT rod string 102. The delivery tube 114 includes a pair of closely spaced flow through ports 130 near an interior end 132 of the delivery tube 114. The pair of closely spaced flow through ports 130 permit fluid entry within the delivery tube 114.

Referring also to FIGS. 1C and 1D, a stop ring generally designated by the reference character 140 defines a plurality of fluid paths for fluid entry into the delivery tube 1 14. The stop ring 140 is a flow though control and positioning member that is secured or screwed within the interior end 132 of the delivery tube 114 retaining the delivery tube within the ejector/injector tool 100.

The stop ring or flow though control and positioning member 140 includes a stepped member 142 and a tubular coupling 146. The exterior surface of the tubular coupling 146 is threaded for mating threaded engagement within the interior end 132 of the delivery tube 114. A plurality of openings 148 is formed through the stepped member 142 to define fluid paths to permit fluid entry into the delivery tube 114 from the CPT rod string 102 via the flow through ports 130. The plurality of openings 148 are, for example, drilled equally spaced on a set diameter through the stepped member 142, as best seen in FIG. 1D.

In FIG. 1A, the CPT rod string 102 is shown retracted with the multiple sets of delivery ports exposed and the closely spaced flow through ports 130 located within the valve body 104 between the pairs of O-rings 120 preventing fluid entry within the delivery tube. To open fluid paths to permit fluid entry within the delivery tube 114 from the CPT rod string 102, the CPT rod string 102 is moved up from the fully extended position, or to the right as shown in FIG. 1A, by a set distance, for example four inches, to locate the flow through ports 130 outside the central tubular opening 106 of the valve body 104.

Ejector/injector tool 100 is arranged with the flow though control and positioning member 140 and valve body 104 for allowing the ports 130 to be locked closed with a positive seal in either an up or down position of the CPT rod string 102. The flow though control and positioning member 140 and valve body 104 of the CPT ejector/injector tool 100 completely eliminate the loss of treatment materials in undesired areas and removes any possibility of flow-back or unwanted backpressure.

In accordance with features of the ejector/injector tool 100 the design of the valve 104 together with the flow though control and positioning member 140 is such that the CPT rod string 102 can be isolated at anytime, keeping the fluid inside of the tool 100 and rod string 102. Ejector/injector tool 100 is arranged to be fully closed with a positive seal when running into the hole. Then the CPT ejector/injector tool 100 is opened to treat a single spot or, for example, up to four feet at a time.

In accordance with features of the ejector/injector tool 100 the ability to treat a single spot or a length of formation, such as up to four feet in length on a single run makes the ejector/injector tool 100 completely unique. Ejector/injector tool 100 is arranged for effective and efficient operation.

Referring also to FIG. 2, in operation the closed CPT ejector/injector tool 100 is pushed into the contamination area to the appropriate depth with the cone 118 latched to the valve body 104. The valve 104 is closed with the flow though control and positioning member 140 so that fluid cannot enter or exit the tool string 102. The soils are blocked from entering and plugging the delivery ports 116 with the delivery tube 114 contained within the valve body 104 and the CPT string 102.

Referring also to FIG. 3, once the CPT ejector/injector tool 100 is pushed to a desired depth, then the cone 118 is unlatched from the valve body 104 and the CPT string 102 together with valve body 104 of the tool 100 are withdrawn a sufficient distance so that selected ports 116 in the inner delivery tube 114 are exposed to the contamination.

As shown in FIG. 3, the CPT string 102 is retracted so that only a first set of ports 116 in the inner delivery tube 114 is exposed and the valve 104 is opened with the flow though control and positioning member 140 so that fluid treatment of a very discrete area is provided.

CPT ejector/injector tool 100 as shown can be withdrawn as little as a few inches up to several feet, such as four feet, at a time. The appropriate treatment material is then sent down the hollow body portion 108 within CPT string 102 to be released through the exposed ports 116 directly into the contaminated area.

To remove or recover the ejector/injector tool 100, the CPT string 102 is lowered so inner delivery tube 114 is completely contained within the body portion 108 and the central tubular opening 106 of the valve body 104 and the cone 118 is latched to the valve body. The entire CPT string 102 is then withdrawn from the hole.

Ejector/injector tool 100 has a selected size consistent with a particular size of the CTP rod string 102. For example, one ejector/injector tool 100 has been designed with an overall length in a closed position of 72 inches and an open or fully extended position length of 120 inches. An outside diameter (O.D.) of one ejector/injector tool 100 is, for example, 1.75 inches, providing an area of 15 square centimeters.

While the present invention has been described with reference to the details of the embodiments of the invention shown in the drawing, these details are not intended to limit the scope of the invention as claimed in the appended claims.

What is claimed is:

1. An ejector/injector tool for use with a CPT rod string comprising:
an annular valve body having a central tubular opening;
a hollow body portion connected at a first end with the CPT rod string and at an opposed end with said annular valve body;
an extendable delivery tube containing a plurality of fluid delivery ports; said extendable delivery tube being received through said valve body into said hollow body portion;
a plurality of O-rings received within said valve body providing a liquid tight fit between said extendable delivery tube and said valve body; and
an interior end of said extendable delivery tube coupled to a stop ring containing a plurality of fluid paths to permit the entry of fluid into said delivery tube.

2. An ejector/injector tool for use with a CPT rod string as recited in claim 1 wherein said annular valve body is releasably connected at one end to a cone shaped member.

3. An ejector/injector tool for use with a CPT rod string as recited in claim 1 wherein said plurality of fluid delivery ports in said extendable delivery tube include a plurality of sets of fluid delivery ports, each set of fluid delivery ports including at least one pair of said fluid delivery ports formed through the delivery tube.

4. An ejector/injector tool for use with a CPT rod string as recited in claim 3 wherein said pair of said fluid delivery ports formed through the delivery tube are located about 180 degrees apart from each other.

5. An ejector/injector tool for use with a CPT rod string as recited in claim 1 wherein said stop ring includes a flow though control and positioning member for defining said plurality of fluid paths.

6. An ejector/injector tool for use with a CPT rod string as recited in claim 1 wherein said extendable delivery tube is contained within said valve body and said hollow body portion when the ejector/injector tool is pushed into a formation.

7. An ejector/injector tool for use with a CPT rod string as recited in claim 6 wherein said stop ring includes a flow though control and positioning member; said flow though control and positioning member being positioned for closing said plurality of fluid paths to contain fluid and to eliminate backpressure from said delivery tube.

8. An ejector/injector tool for use with a CPT rod string as recited in claim 1 wherein said hollow body portion and the CPT rod string is retracted to expose a selected one of said plurality of fluid delivery ports or multiple ones of said plurality of fluid delivery ports when the ejector/injector tool is located at a selected depth in a formation.

9. An ejector/injector tool for use with a CPT rod string as recited in claim 8 wherein said stop ring includes a flow though control and positioning member; said flow though control and positioning member being positioned to define said fluid paths to permit the entry of fluid into said delivery tube.

10. An ejector/injector tool for use with a CPT rod string as recited in claim 1 wherein said plurality of fluid delivery ports in said extendable delivery tube are spaced apart at a set interval along said extendable delivery tube.

11. An ejector/injector tool for use with a CPT rod string comprising:
an annular valve body having a central tubular opening;
a hollow body portion connected at a first end with the CPT rod string and at an opposed end with said annular valve body;
an extendable delivery tube containing a plurality of sets of fluid delivery ports; said plurality of sets of fluid delivery ports being spaced apart at a set interval along said extendable delivery tube;
said extendable delivery tube being received through said valve body into said hollow body portion;
a plurality of O-rings received within said valve body providing a liquid tight fit between said extendable delivery tube and said valve body; and
an interior end of said extendable delivery tube coupled to a stop ring containing a plurality of fluid paths to permit the entry of fluid into said delivery tube.

12. An ejector/injector tool for use with a CPT rod string as recited in claim 11 wherein each said set of fluid delivery ports includes at least one pair of said fluid delivery ports formed through said delivery tube.

13. An ejector/injector tool for use with a CPT rod string as recited in claim 12 wherein said at least one pair of said fluid delivery ports formed through said delivery tube are located about 180 degrees apart from each other.

14. An ejector/injector tool for use with a CPT rod string as recited in claim 11 wherein said annular valve body is releasably connected at a distal end to a cone shaped member.

15. An ejector/injector tool for use with a CPT rod string as recited in claim 11 wherein said stop ring includes a flow though control and positioning member for defining said plurality of fluid paths.

16. An ejector/injector tool for use with a CPT rod string as recited in claim 11 wherein said extendable delivery tube is contained within said central tubular opening of said valve body and said hollow body portion when the ejector/injector tool is being pushed into a formation and being removed from the formation.

17. An ejector/injector tool for use with a CPT rod string as recited in claim 11 wherein said hollow body portion and the CPT rod string is retracted to expose a selected set of said plurality of fluid delivery ports or multiple sets of said plurality of fluid delivery ports when the ejector/injector tool is located at a selected depth in a formation.
